(19) United States
(12) Patent Application Publication
(10) Pub. No.: US 2019/0162160 A1
(43) Pub. Date: May 30, 2019

(54) RUNNER FOR A PELTON TURBINE

(71) Applicant: Voith Patent GmbH, Heidenheim (DE)

(72) Inventor: Reiner Mack, Dettingen (DE)

(73) Assignee: Voith Patent GmbH, Heidenheim (DE)

(21) Appl. No.: 16/265,405

(22) Filed: Feb. 1, 2019

Related U.S. Application Data
(63) Continuation of application No. PCT/EP2017/064525, filed on Jun. 14, 2017.

(30) Foreign Application Priority Data
Aug. 1, 2016 (DE) 10 2016 214 126.0

(51) Int. Cl. F03B 1/02

(52) U.S. Cl. CPC F03B 1/02; F05B 2260/30

(57) ABSTRACT

A runner for a Pelton turbine having a runner hub and a plurality of buckets which in each case have one bucket root. Each bucket is mounted on the runner hub with the bucket root and each bucket includes a cavity which encloses an area configured in such a manner that they passively counteract an occurring bucket oscillation. Where at least one body is movable in respect to cavity.

### CROSS REFERENCE TO RELATED APPLICATIONS

This is a continuation of PCT application No. PCT/EP2017/064525, entitled “RUNNER FOR A PELTON TURBINE”, filed Jun. 14, 2017, which is incorporated herein by reference.

### BACKGROUND OF THE INVENTION

### 1. Field of the Invention

The current invention relates to a runner for a Pelton turbine.

### 2. Description of the Related Art

The buckets of a runner for a Pelton turbine are cyclically strained due to the jet action. Load changes in the range of 10⁸ to 10¹⁰ are not unusual for a projected life span of 50 years. The bucket moreover experiences an additional load due to the natural oscillation behavior of the bucket itself. Since damping of the material and the flowing water is relatively low, amplitudes of the harmonic can occur in the case of resonance, which are in part even higher than those of the jet action. During the design process, the natural frequency of the buckets can be adjusted accordingly non-critical so that the harmonics of the frequency with which the jet passes the bucket are far enough removed from the natural frequency of the buckets. However, slight changes during the manufacturing process can cause a displacement of the natural frequency of the buckets, so that the safety factor that is incorporated in the design, between the aforementioned frequencies is reduced. In this context we refer you to the publication by Reiner Mack and Christian Probst, Evaluation of the dynamic behavior of a Pelton runner based on strain gauge measurements, 2016 IP Conf. Ser.: Earth, Environ Sci #49 022001.

What is needed in the art, is a generic runner which is less sensitive in regard to an inducement of a natural frequency of the buckets and which therefore provides greater security in regard to unintended resonance effects.

### SUMMARY OF THE INVENTION

The invention in one form is directed to a method for producing a runner for a Pelton turbine. The method including using a three-dimensional printer to assist with producing a runner hub and a plurality of buckets. The plurality of buckets each having one bucket root and one cavity. The plurality of buckets being mounted on the runner hub with each bucket root. Each cavity encloses at least one device configured to passively counteract an occurring bucket oscillation. The device includes at least one body which is movable in respect to each cavity.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 illustrates an embodiment of a bucket of a runner formed according to the invention;

FIG. 2 illustrates another embodiment of a bucket of a runner formed according to the invention.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

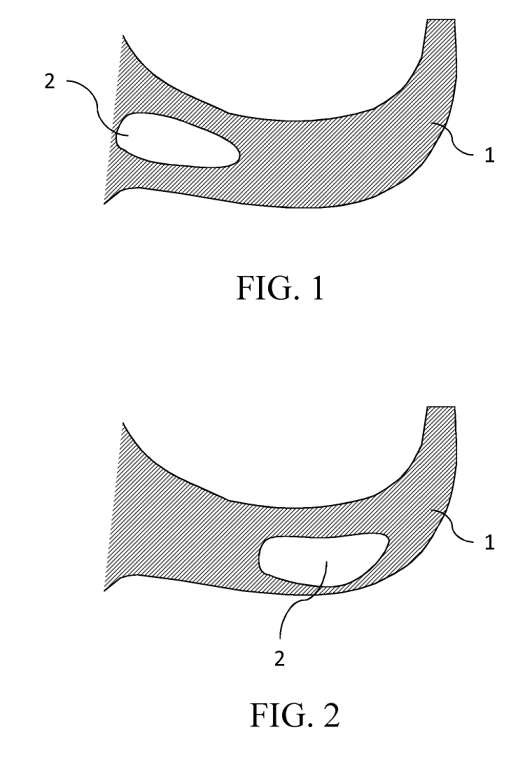

Referring now to the drawings, and more particularly to FIG. 1 there is shown a section through a strongly schematized bucket 1 of a runner according to the invention. Such a bucket 1 is connected via the so-called bucket roots with the runner hubs. A cavity 2 is located in the root region of the illustrated bucket 1. Cavity 2 encloses a device whose function is to counteract a bucket oscillation.

In the event of a damaging bucket oscillation, a deformation occurs in the region of the bucket root. If damping is increased in this region, the bucket oscillation can be effectively countered. The device in cavity 2 must therefore have a damping effect. The area can consist of movable bodies, which upon deformation of the bucket root, rub against one another thus introducing effective damping. Suitable movable bodies can consist for example of granulate, metallic powder or other materials that can rub against one another. In addition, the cavity may also be filled with a liquid. Use of a liquid that has a high viscosity can further enhance damping. Moreover, more than one cavity may be located in the region of the bucket root. It is clear that the cavities must be sized such that the structural rigidity of the bucket roots remains sufficiently high. A cavity may also consist of several individual chambers. These chambers can be of a honeycomb design. Use of multiple chambers or respectively a honeycomb construction offers the advantage that the structural rigidity of the bucket root is not drastically reduced and that the moveable bodies do not settle in one segment of the cavity.

FIG. 2 is a sectional view through another embodiment of and a heavily schematized bucket 1 of an inventive runner. A cavity 2 is located in the region of the backside of the bucket. Cavity 2 encloses device whose function it is to counteract a bucket oscillation. In the event of a bucket oscillation, a periodic deflection occurs in the region of the backside of the bucket. The bucket oscillation in this region can be countered in that a movable body is integrated in this location in cavity 2 which can be activated through jet action to a periodic counter-phase movement in relation to the bucket oscillation. It may be advantageous if the moveable body has the greatest possible mass. The movable body can also be embedded into a liquid.

The inventive embodiments according to FIG. 1 and FIG. 2 can also be used in combination. In other words, each bucket has a cavity in the region of the bucket root and in the region of the backside of the bucket.

It is also conceivable that the cavities include a device which actively counteracts a bucket oscillation. Actively acting requires suitable control and an energy source. However, passive elements have the additional advantage that they are resilient against defects, thus ensuring durable effectiveness.

It is also conceivable that, the cavities are not located at the back of the bucket, but in another region of the bucket that is sufficiently far removed from the bucket root for instance, the bucket 1 back side.

Furthermore, the embodiments can be produced with the assistance of a suitable 3D-printing process.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for producing a runner for a Pelton turbine, the method comprising:
using a three-dimensional printer to assist with producing:
a runner hub; and
a plurality of buckets, each of the plurality of buckets having one bucket root and being mounted on the runner hub with the corresponding bucket root, each of the plurality of buckets having a cavity enclosing at least one device configured to passively counteract an occurring bucket oscillation, the device including at least one body which is movable in respect to the corresponding cavity.

2. The method according to claim 1, wherein each cavity is located in a region of each bucket root, the at least one device in each cavity is a plurality of movable bodies, the plurality of movable bodies being configured to dampen the occurring bucket oscillation by contacting one another.

3. The method according to claim 1, wherein each cavity is located in a region of the bucket backside, the at least one device in each cavity is one movable body, the one movable body having a period movement that is counter-phase to the occurring bucket oscillation.

4. The method according to claim 2, wherein the plurality of movable bodies are a granulate or a metallic powder.

5. The method according to claim 2, wherein each cavity is subdivided into several chambers, wherein each chamber encloses several of the plurality of movable bodies.

6. The method according to claim 2, wherein each cavity has a honeycomb design, wherein each honeycomb encloses several of the plurality of movable bodies.

7. The method according to claim 3, wherein the one movable body has the greatest possible mass.

8. The method according to claim 2, wherein each cavity is filled with a liquid.

9. The method according to claim 8, wherein the liquid has a high viscosity.
